(19) United States
(12) Patent Application Publication
(10) Pub. No.: US 2010/0293391 A1
(43) Pub. Date: Nov. 18, 2010

(54) MULTIPOINT GENERAL-PURPOSE INPUT/OUTPUT CONTROL INTERFACE DEVICE

(76) Inventor: JENN-LUN JOUE, San Chung (TW)

Correspondence Address: LEONG C. LEI, PMB # 1008, 1839 YGNACIO VALLEY ROAD, WALNUT CREEK, CA, 94598, US

(21) Appl. No.: 12/766,926

(22) Filed: Apr. 26, 2010

(30) Foreign Application Priority Data
May 13, 2009 (TW) 098115808

(51) Int. Cl. G06F 21/22; G06F 3/00; G06F 12/00; G06F 1/14; G06F 1/28; G06F 12/14

(52) U.S. Cl. 713/190; 710/5; 726/26; 711/104; 711/103; 713/500; 713/340; 711/E12.092; 711/E12.001

(57) ABSTRACT

A multipoint general-purpose input/output control interface device is provided, which is a control interface device that is applicable to, but not limited to, PCI transmission interface, and can be installed in or removed from a computer system or a game machine as desired to use the computer system or the game machine to control a timer and access or encrypt static random access memory and general purpose input/output (GPIO).

### (A) TECHNICAL FIELD OF THE INVENTION

The present invention generally relates to a control interface device that can be installed in either a computer system or a game machine and uses the computer system or the game machine to control input/output devices and access and/or encrypt static random access memory (SRAM).

### (B) DESCRIPTION OF THE PRIOR ART

For the currently available electronic/electric systems, the operation of non-standard electronic device must be controlled through a control interface that is provided by individual device or mechanism, such as being controlled by individual pushbuttons of a keypad, coin receiving/returning mechanisms, and a purchasing button of a game machine, or audio/video buttons of a multimedia device, a function module selection button of a joy stick of a game machine, and pushbuttons of a POS system.

To meet the needs for various input/output interfaces for peripheral devices of an electronic system, an embedded controller IC (EC-IC) must be provided in addition to the system. Such a control unit provides a peripheral function controller is of a fixed form, whereby once the control unit is constructed, there is no way to make any modification of the functions thereof. Further, the control unit must be embedded in the main board or chipset of the system. If a user attempts to apply the control functions of such a control unit in a different system, a system main board in which the control unit is embedded must be additionally purchased or replaced, leading to additional costs. Further, it is not possible to install the control unit in an existing electronic device according to the requirements of control at any time or to remove the control unit from a first electronic device for mounting to a second electronic device. This is certainly troublesome.

Further, the conventional electronic devices/systems provide only very simple protection of security code for recorded data and apparently, there is still quite a space for improvement of data security.

### SUMMARY OF THE INVENTION

The primary objective of the present invention is to construct architecture of operation function controller for a programmable control processing module in a simple configuration by adopting field programmable gate array (FPGA) technology, whereby a user is allowed to design programs according to various requirements for controlling a multipoint general-purpose input/output port through a programmable control processing module to realize timing control, interruption control, and protection of data with control data being transmitted through at least one peripheral function device interfaced therewith.

Another objective of the present invention is to provide a control interface device that is connectable and thus controls various input/output interfaces, and/or a control interface device that can be combined with various electronic devices and allows for edition of desired control function, and/or a control interface device that provides a security function of data encryption, and/or a control interface device that reduces the requirements for system input and outputs.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing architecture of the present invention in an in-operation condition.

FIG. 2 is a block diagram of a programmable control processing module according to the present invention.

FIG. 3 is a schematic view illustrating the present invention connected to a security recording module.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

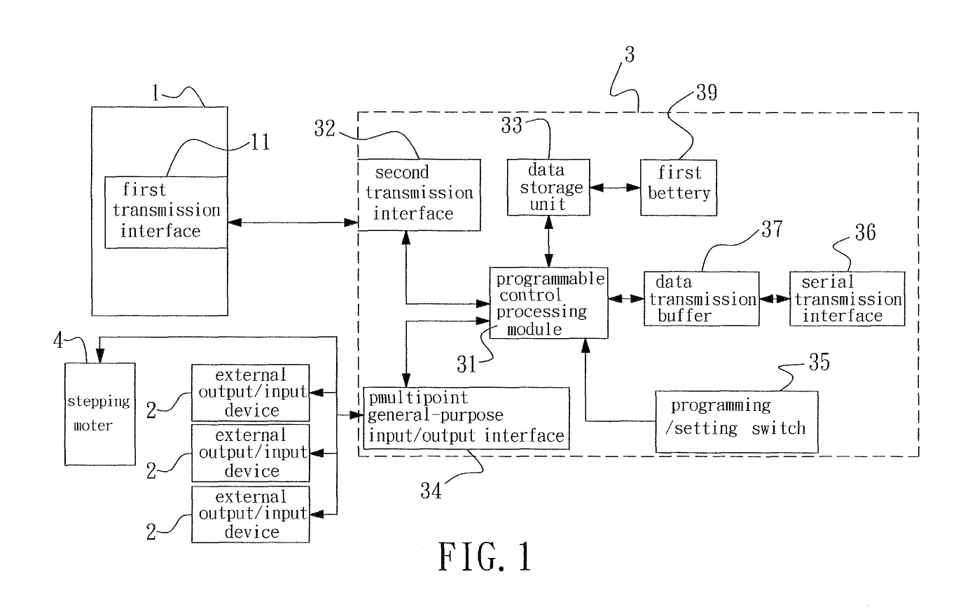

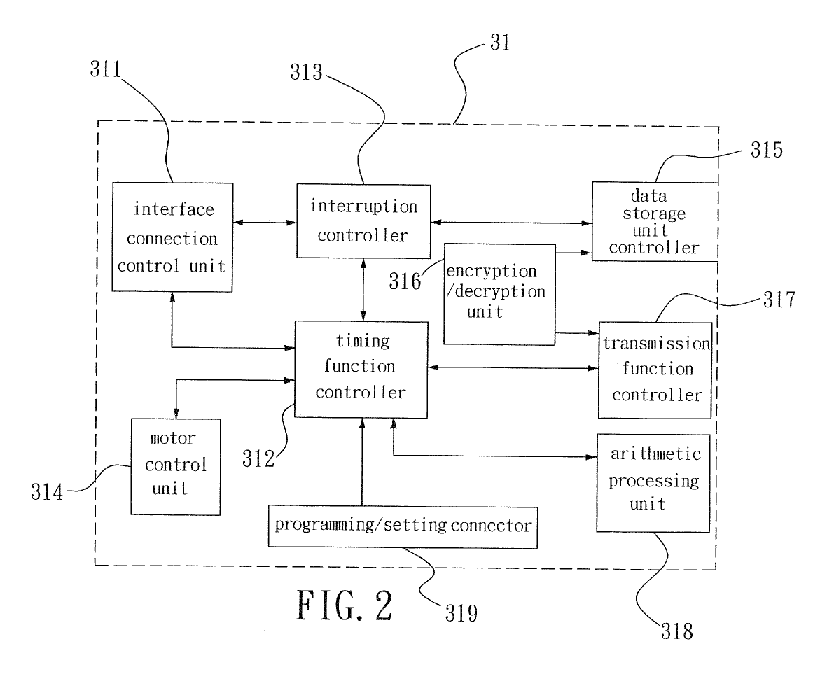

Referring to FIG. 1, the present invention provides a multipoint general-purpose input/output control interface device 3, which is simultaneously connectable with an electronic device 1, one or more external output/input devices 2, and a stepping motor 4. Referring simultaneously to FIGS. 1 and 2, the multipoint general-purpose input/output control interface device 3 comprises a programmable control processing module 31 as a core portion thereof, which is connected to a second transmission interface 32, a multipoint general-purpose input/output interface 34, a programming/setting switch 35, a data transmission buffer 37, and a data storage unit 33. The data transmission buffer 37 is further connected with a serial transmission interface 36.

The control processing module 31 preferably comprises a field programmable gate array (FPGA), whereby when there is a need to work with different system or in different applications, such as interfacing the present invention to a different electronic device or when there is a need to modify the circuit logic, edition can be performed on the control processing module 31.

The second transmission interface 32 is electrically connectable with a first transmission interface 11 of the electronic device 1 to receive control data transmitted from the electronic device 1; and the multipoint general-purpose input/output interface 34 may comprise general purpose I/O (GPIO). The first transmission interface 11 and the second transmission interface 32 can be mateable plug and socket, but not limited thereto, such as PCI, PCI-E, USB interface, and IEEE1394 interface. Further, the serial transmission interface 36 is a serial peripheral interface (SPI), which provides interface transmission control for flash, or the serial transmission interface 36 is used to control interfaces of ADC, PLL, RTC, LIU, CODEC, or an equivalent circuit, such as an inter-integrated circuit (I²C), that realizes serial transmission of data can be applied.

The data storage unit 33 can be static random access memory (SRAM) or flash memory, but not limited thereto, and may be composed of more than one set of memory devices. The data storage unit 33 is further electrically connected to a first battery 39, which provides emergency power to help preserving data stored in the data storage unit 33 when failure of external power occurs.

The programming/setting switch 35 comprises a dip switch, which allows for switching among different settings, including event probability, parameter variation, speed setting, and generates a control signal to the control processing module 31.

Referring to FIG. 2, which shows a block diagram of the control processing module 31, the control processing module 31 comprises at least a motor control unit 314, an encryption/decryption unit 316, an arithmetic processing unit 318, an interface connection control unit 311, a timing function controller 312, an interruption controller 313, a data storage unit controller 315, a transmission function controller 317, and a programming/setting connector 319. The motor control unit 314 controls actuation and de-actuation of the stepping motor 4. The encryption/decryption unit 316 functions to apply a process of Advanced Encryption Standard (AES) for encryption and decryption. In other words, recorded data can be encrypted with a pubic key through the AES process and stored in the data storage unit 33. When a user at the electronic device 1 attempts to use a general purpose procedure interface of the electronic device 1 to access the recorded data, a private key must be presented in order to decrypt the data. However, the data can be encrypted with other processes, such as DES, Hash, and RAS.

The interface connection control unit 311 is electrically connected to the second transmission interface 32 and the multipoint general-purpose input/output interface 34.

The timing function controller 312 is electrically connected to the interface connection control unit 311 for controlling operation timing of the external output/input device(s) 2.

The interruption controller 313 functions to perform interruption according to the control data to control the change of the electronic device 1 or the external output/input device(s) 2.

The data storage unit controller 315 functions for access control of the recorded data.

The transmission function controller 317 functions to control data transmission between the programmable control processing module 31 and the data transmission buffer 37.

The programming/setting connector 319 is electrically connected to the programming/setting switch 35 for programming setting. For example, in the embodiment illustrated, the programming/setting switch 35 comprises an 8-bit dip switch, which comprises switching elements of which combinations representing different meanings that can be pre-set or set or edited through the general purpose procedure interface of the electronic device 1. For example, in the case that the electronic device 1 is a game machine, a first switching element can be set in such a way that an “ON” condition indicates doubling the point gained in the game and an OFF condition means regular setting of the game points; or a plurality of switching elements can be set, in combination, in all ON condition to force the external output/input device(s) 2 into a standby maintenance mode.

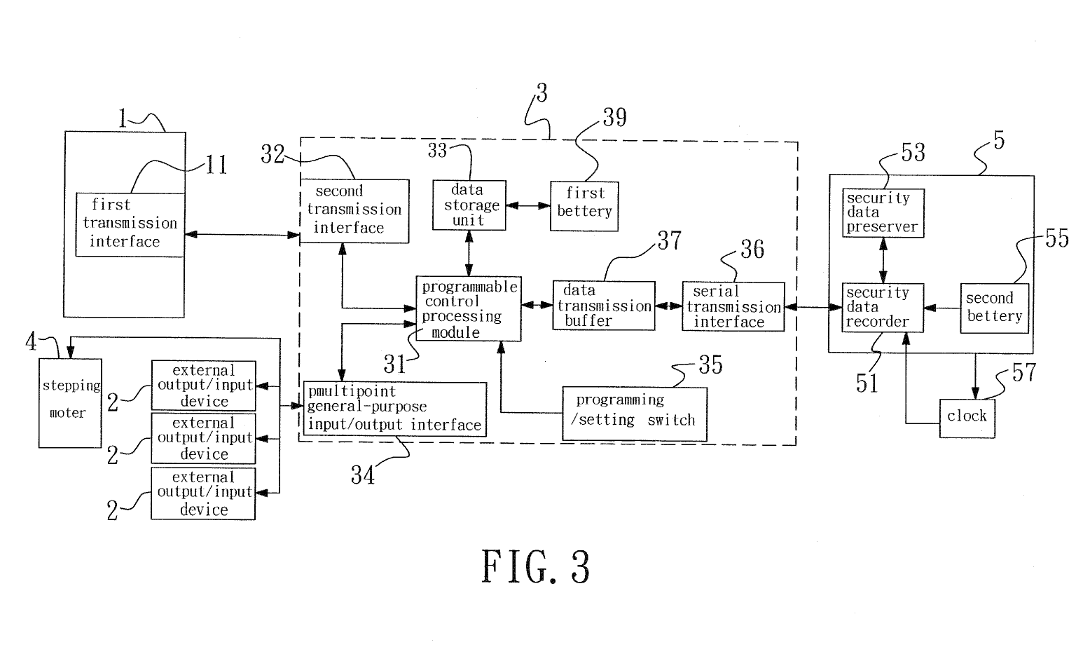

Referring to FIG. 3, the multipoint general-purpose input/output control interface device 3 of the present invention connects a security recording module 5 through the serial transmission interface 36 to the data transmission buffer 37 for monitoring any operation that an external user might take on the electronic device 1 of the present invention. The security recording module 5 comprises a security data recorder 51, a security data preserver 53, a second battery 55, and a real time clock 57 interconnecting each other. When a person opens a housing of the electronic device 1 with an attempt to change the setting of the programming/setting switch, the security data recorder 51 makes a record of that operation, and such security data, together with the data of the real time clock 57, are preserved in the security data preserver 53, so as to realize monitoring of change of the system, as well as system modification that is made manually or non-manually. The second battery 55 supplies electrical power to maintain the security data in the security data recorder 51 and to power the real time clock 57 in case of power failure, whereby the security data will not get lost due to power failure. The serial transmission interface 36 can be connected to an external device, such as a read only memory (ROM) or a timer. The security recording module 5 and the multipoint general-purpose input/output control interface device 3 can be arranged in the same circuit or can be arranged as external devices according to the needs.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multipoint general-purpose input/output control interface device, which is adapted to selectively connect with an electronic device comprising a first transmission interface, an external output/input device, and a stepping motor, so as to perform programming and setting to generate control data for controlling operations of the stepping motor and the external output/input device, wherein:
the multipoint general-purpose input/output control interface device comprises a second transmission interface electrically connectable to the first transmission interface for data transmission with the electronic device; a programmable control processing module electrically connected to the second transmission interface for receiving and processing the control data to generate recorded data; a multipoint general-purpose input/output interface electrically connected to the programmable control processing module for connection with the external output/input device and the stepping motor; a data storage unit electrically connected to the programmable control processing module for storing the recorded data; a data transmission buffer electrically connected to the programmable control processing module for buffering and storage of the recorded data; and a serial transmission interface electrically connected to the programmable control processing module.

2. The multipoint general-purpose input/output control interface device according to claim 1, wherein the programmable control processing module comprises an encryption/decryption unit for encryption and decryption of the control data and the recorded data; an interface connection control unit electrically connected to the second transmission interface, the serial transmission interface, and the multipoint general-purpose input/output interface for controlling inter-interface transmission; a timing function controller electrically connected to the interface connection control unit for controlling operation timing of the external output/input device and the stepping motor; a motor control unit electrically connected to the timing function controller for controlling actuation and de-actuation of the stepping motor; an arithmetic processing unit electrically connected to the timing function controller for computation and preservation of the recorded data; an interruption controller electrically connected to the interface connection control unit for carrying out interruption according to the control data; a data storage unit controller electrically connected to the data storage unit for handling access control of the recorded data; a transmission function controller electrically connected to the data transmission buffer for controlling data transmission between the programmable control processing module and the data transmission buffer; and a programming/setting connector electrically connected to a programming/setting switch for programming and setting.

3. The multipoint general-purpose input/output control interface device according to claim 1, wherein the first and second transmission interfaces are mateable plug and socket selected from a group consisting of PCI, PCI-E, USB interface, and FireWire IEEE 1394.

4. The multipoint general-purpose input/output control interface device according to claim 1, wherein the programmable control processing module comprises a field programmable gate array (FPGA) circuit.

5. The multipoint general-purpose input/output control interface device according to claim 1, wherein the serial transmission interface comprises a serial peripheral interface (SPI).

6. The multipoint general-purpose input/output control interface device according to claim 1, wherein the encryption/decryption unit comprises an Advanced Encryption Standard (AES) encryption/decryption unit.

7. The multipoint general-purpose input/output control interface device according to claim 1, wherein the data storage unit selectively comprises one of static random access memory (SRAM) and flash memory.

8. The multipoint general-purpose input/output control interface device according to claim 1, wherein the programmable control processing module is connected to a programming/setting switch.

9. The multipoint general-purpose input/output control interface device according to claim 8, wherein the programming/setting switch comprises a dip switch.

10. The multipoint general-purpose input/output control interface device according to claim 1, wherein the data storage unit is connected to a first battery.

11. The multipoint general-purpose input/output control interface device according to claim 1, wherein the data transmission buffer is connected to a security recording module.

12. The multipoint general-purpose input/output control interface device according to claim 11, wherein the data transmission buffer is connected to the security recording module through the serial transmission interface.

13. The multipoint general-purpose input/output control interface device according to claim 11, wherein the security recording module comprises a security data recorder electrically connected to the data transmission buffer for recording security data; a security data preserver electrically connected to the security data recorder for preserving the security data, a real time clock electrically connected to the security data recorder for providing timing for recording of security data; and a second battery electrically connected to the security data recorder and the real time clock to provide electrical power for maintaining the security data of the security data recorder and the real time clock in case of power failure.

14. A multipoint general-purpose input/output control interface device comprising a programmable control processing module as a core, which is electrically connected to a second transmission interface, a programming/setting switch, a data transmission buffer, and a data storage unit to form a complete device.

15. A programmable control processing module for a multipoint general-purpose input/output control interface device comprising, but not limited to, a timing function controller connected to an interface connection control unit, an interruption controller, a programming/setting connector, and a transmission function controller, the interruption controller being connected to a data storage unit controller and the interface connection control unit.
